(19) United States
(12) Patent Application Publication
(10) Pub. No.: US 2009/0313666 A1
(43) Pub. Date: Dec. 17, 2009

(54) Television Content Management for Clients

(75) Inventors: Sascha Pruter, San Francisco, CA (US); Fransiscus W. Vink, Amsterdam (NL); James A. Baldwin, Redwood City, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/141,047

(22) Filed: Jun. 17, 2008

(51) Int. Cl. H04N 7/173; G06F 15/16

(52) U.S. Cl. 725/93; 725/86; 709/231; 725/98

(57) ABSTRACT

Techniques to manage television content for clients are described. In an implementation, a call is formed to an application programming interface (API) to include an identifier of a client that requested television content and a network address via which the television content is accessible. Whether the television content is to be streamed to the client is managed based on an answer that is received responsive to the call; and includes a result of a determination of whether the client is permitted to consume the television content from the network address.

### BACKGROUND

Digital rights management techniques have been developed to protect television content from unauthorized access. In one traditional technique, public/private key pairs were utilized with asymmetric encryption techniques to prevent users that did not have the private key from accessing the television content that was encoded using the public key. This scheme traditionally kept the private key secret by incorporating the private key in hardware at a client that was to receive the television content.

However, even though a traditional private key was maintained in hardware at the client, malicious parties may still be able to access the private key, such as by “snooping” the private key. Once exposed, the private key may be used to defeat these traditional DRM techniques, such as by sharing the key between client devices. Additionally, because television content was traditionally broadcast to each client, and then the clients were traditionally relied upon to perform the DRM techniques locally, clients having the exposed keys were provided with easy access to a wide range of content even if the clients were not authorized to do so. Consequently, exposure of the traditional private key may defeat these traditional DRM techniques in a relatively short amount of time.

### SUMMARY

Techniques to manage television content for clients are described. In an implementation, a call is formed to an application programming interface (API) to include an identifier of a client that requested television content and a network address via which the television content is accessible. Whether the television content is to be streamed to the client is managed based on an answer that is received responsive to the call. The answer includes a result of a determination of whether the client is permitted to consume the television content from the network address.

In an implementation, a log is collected by a network operator that describes interaction of a client with television content. A determination is made as to whether the client is permitted to access the television content described in the log. Communication of subsequent television content is managed based on the determination.

In an implementation, an apparatus includes one or more modules to connect a plurality of digital subscriber lines to an Internet backbone using one or more multiplexing techniques, in which each of the plurality of digital subscriber lines is connectable to a respective one or more of a plurality of clients. The one or more modules are also configured to manage whether requested television content is to be streamed to one or more of the clients by forming a call to an application programming interface (API) to determine whether the one or more clients are permitted to receive the requested television content.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques to perform content selection and output.

FIG. 2 depicts a system in an example implementation in which a network authority module of FIG. 1 is illustrated as being implemented by a digital subscriber line access multiplexer (DSLAM).

FIG. 3 is a flowchart that describes a procedure in an example implementation in which client consumption of content is managed using an API call to a backend.

FIG. 4 is a flowchart that describes a procedure in an example implementation in which communication of television content to a client is managed based on a log collected from the client that describes client interaction with television content.

### DETAILED DESCRIPTION

Overview

Traditional digital rights management techniques that were employed with television content were centralized at the client. For example, the client may use a private key protected in hardware to decode content received via a broadcast network. However, even though the hardware offered some protection for the private key at the client, it was still possible for malicious parties to obtain the private key from the hardware, e.g., such as by snooping the hardware. The private key could then be exposed for use by other clients, which may then obtain unauthorized access to the television content thereby defeating the traditional digital rights management techniques.

Television content management for clients is described. In an implementation, a network operator is able to manage which content is received by which clients. For example, a device may be employed by the network operator to provide control over which streams the client is allowed to receive. Therefore, even if the client is provided with a wrongfully obtained private key, the client does not obtain the television content that is to be decoded using the private key. A variety of different techniques may be used to manage which content is provided to which clients.

For example, a backend of the network operator may provide an application programming interface (API) that is accessible by one or more devices that stream content to the clients. The API may be used to determine whether clients are permitted to consume requested content. For instance, a digital subscriber line access multiplexer (DSLAM) may be configured to stream television content to clients over respective digital subscriber lines.

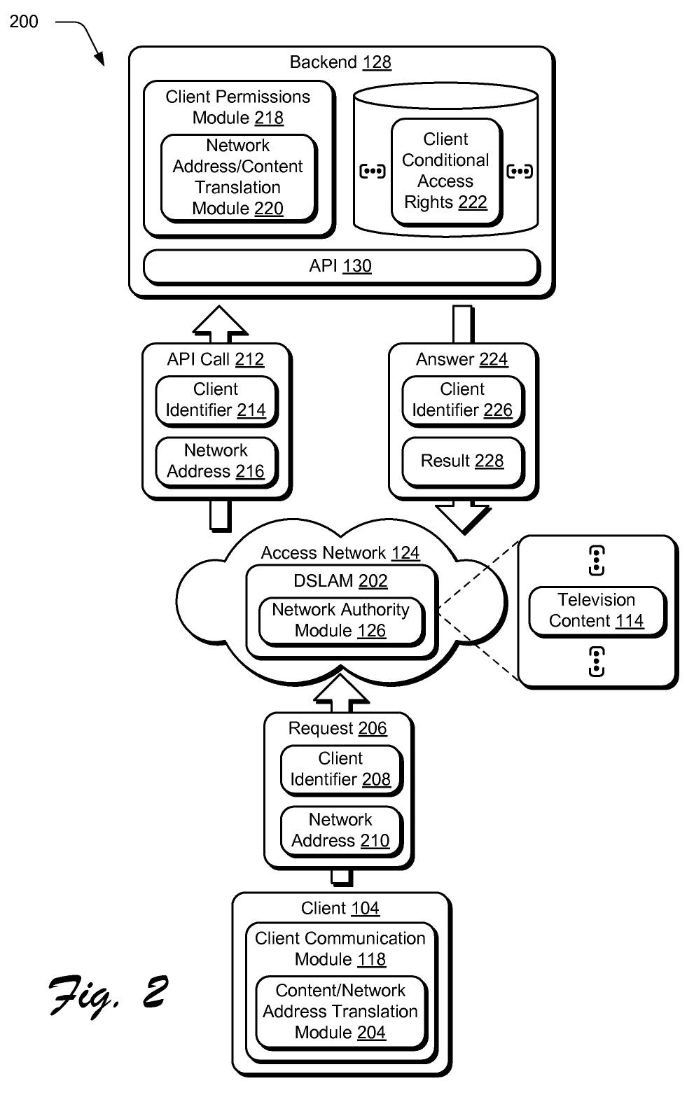

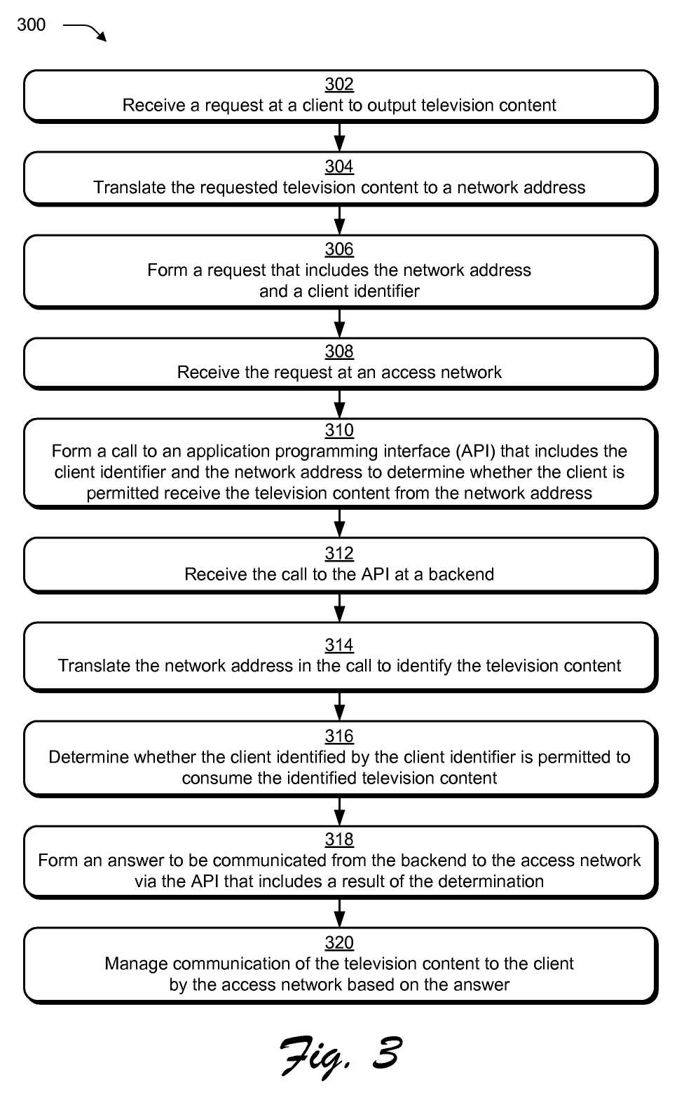

The DSLAM may call the API to determine whether access to particular content that was requested by a client is permitted. Based on an answer received via the API from the backend, the DSLAM may block particular clients from receiving streams of requested content that is not permitted to be consumed by the client. Therefore, even if the client is able to receive a wrongfully obtained private key, the client is still not able to output content that is requested but is not permitted to be accessed by the client because the client does not receive the television content. Further discussion of the use of the API to confirm whether clients are permitted to access content from the network operator may be found in relation to FIGS. 2 and 3.

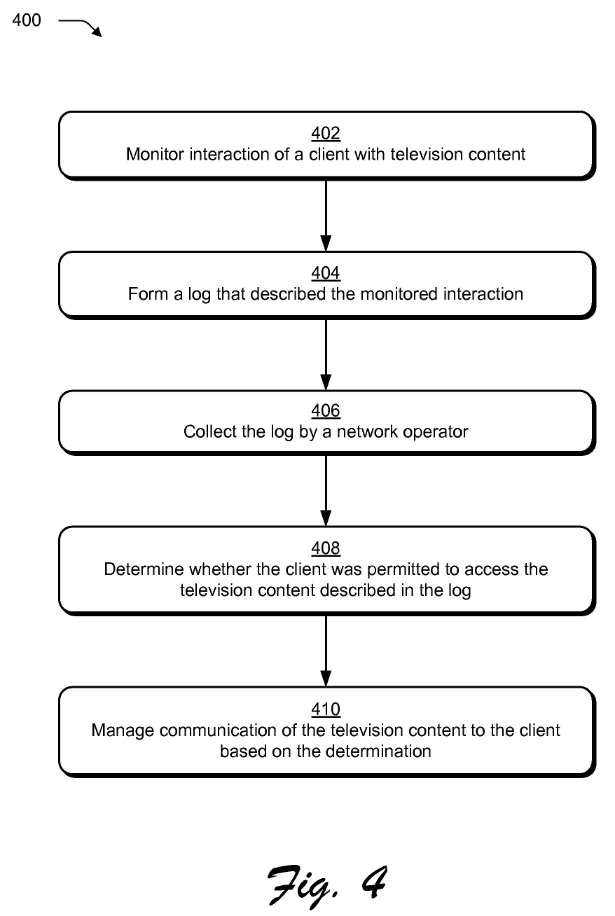

In another example, a forensic stream monitoring technique is described. In this example, the network operator may collect logs obtained from each of the clients. The logs describe which content is being accessed by which client. The network operator may check these logs to determine whether each of the clients is permitted to consume the television content described in the logs. Using this information, the network operator may block specific streams of television content to clients that do not have conditional access rights to those streams. A variety of other examples are also contemplated, further discussion of which may be found in relation to FIG. 4.

In the following discussion, an example environment and systems are first described that are operable to perform techniques to manage provision of television content to clients. Example procedures are then described that may be employed in the example environment, as well as in other environments. Although content management is described in a television environment in the following discussion, it should be readily apparent that a wide variety of environments may be utilized without departing from the spirit and scope thereof.

Example Environment

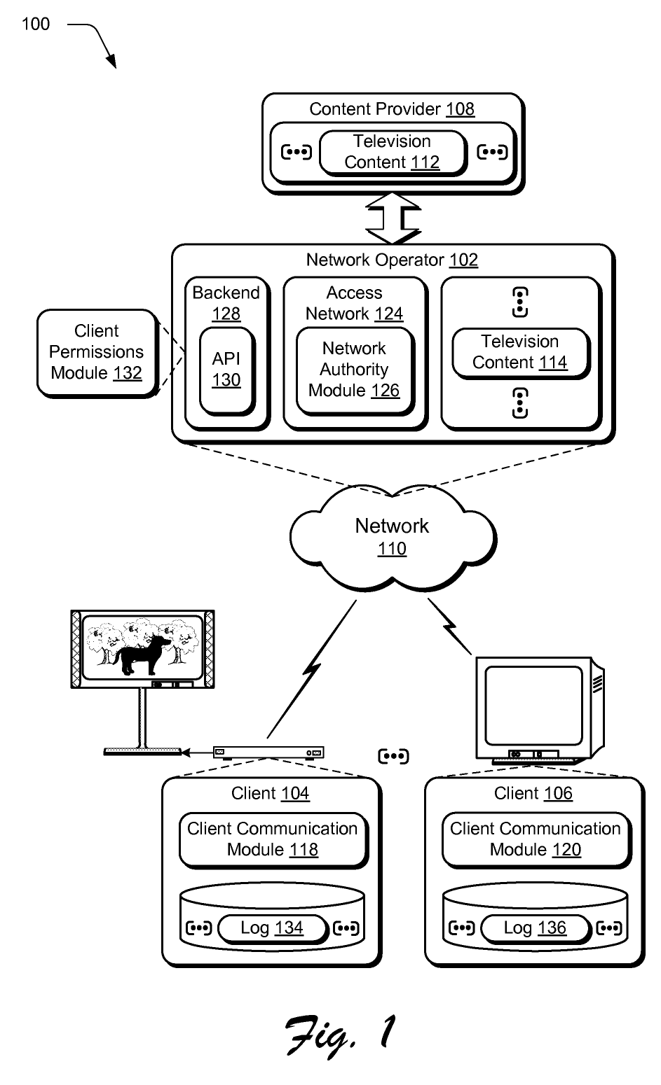

FIG. 1 is an illustration of an environment 100 in an example implementation that is operable to employ techniques to manage television content. The illustrated environment 100 includes a network operator 102 (e.g., a “head end”), first and second clients 104, 106 and a content provider 108. The network operator 102, the first client 104 and the second client 106 are illustrated as being communicatively coupled, one to another, via a network 110.

Although a single network 110 is shown, the network 110 may be representative of a plurality of network connections that may be achieved using a single network or multiple networks, e.g., network 110 may be implemented via the Internet, a cable network, an “over the air” broadcast network, and so on. In the following discussion, the network operator 102, the clients 104, 106, the content provider 108 may also be representative of one or more entities, and therefore by convention reference may be made to a single entity (e.g., the network provider 102) or multiple entities (e.g., the network providers 102, the plurality of network providers 102, and so on).

The clients 104, 106 may be configured in a variety of ways. For example, the clients 104, 106 may be configured as a device that is capable of communicating and/or receiving communications of data over the network 110, such as a television and set-top box as illustrated for client 104, a mobile station, an entertainment appliance (e.g., a game console), a television as illustrated for client 106, a wireless phone, and so forth. Thus, the clients 104, 106 may range from full resource devices with substantial memory and processor resources (e.g., television-enabled personal computers, television recorders equipped with hard disk) to a low-resource device with limited memory and/or processing resources (e.g., traditional set-top boxes).

The television content 112 may include a variety of data. For example, the television content 112 may be configured as television programming, pay-per-view (PPV) movies, video-on-demand (VOD), and so on.

Television content 112, as illustrated in FIG. 1, is communicated to the network operator 102 (e.g., via a network connection and/or computer-readable media) and may be stored as one or more items of television content 114. The television content 114 may be the same as or different from the television content 112 received from the content provider 108. The television content 114, for instance, may include additional data for broadcast to the client 104. For example, the television content 114 may include electronic program guide (EPG) data from an EPG database for broadcast to the client 104 utilizing a carousel file system and an out-of-band (OOB) channel. Distribution from the network operator 102 to the client 104 over network 110 may be accommodated in a number of ways, including cable, radio frequency (RF), microwave, digital subscriber line (DSL), and satellite using a variety of networks as previously described for network 110.

The clients 104, 106, as previously stated, may be configured in a variety of ways to receive the television content 114 via the network 110. The clients 104, 106 typically include hardware and software to transport and decrypt television content 114 received from the network operator 102 for output and rendering, e.g., by the illustrated display devices. Although display devices are shown, a variety of other output devices are also contemplated, such as speakers. Further, although the display device is illustrated separately from the client 104, it should be readily apparent that a client may also include the display device as an integral part thereof as illustrated for client 106.

The clients 104, 106 may also include digital video recorder (DVR) functionality. For instance, the clients 104, 106 may include storage as illustrated to record television content 114. The storage may be configured in a variety of ways, such as a hard disk drive, a removable computer-readable medium (e.g., a writable digital video disc), and so on. Thus, content that is stored in the storage device of the clients 104, 106 may be copies of the television content 114 that was streamed from the network operator 102. Additionally, television content 114 may be obtained from a variety of other sources, such as from a computer-readable medium that is accessed by the client 104, and so on. For example, television content may be written to and stored by a digital video disc (DVD) when the clients 104, 106 are configured to include writable DVD functionality.

The clients 104, 106 include respective client communication modules 118, 120 that are representative of functionality of the respective clients 104, 106 to control content interaction, such as through the use of one or more “control functions”. The control functions may include a variety of functions to control output of television content 114, such as to control volume, change channels, select different inputs, configure surround sound, and so on. The control functions may also provide non-linear playback of the television content 114 (i.e., time shift the playback of the television content) such as pause, rewind, fast forward, slow motion playback, and the like when in a VOD example.

When output of the television content 114 is requested, the client communication modules 118, 120 may form a request to the network operator 102 to retrieve and then stream the television content 114 via the network 110. The client communication modules 118, 120 may also restore the television content 114 to the original encoded format as received from the content provider 108.

Thus, in the environment 100 of FIG. 1, the content provider 108 may provide the television content 112 to a multiplicity of network operators, an example of which is illustrated as network operator 102. The network operator 102 may then stream the television content 114 over a network 110 to a multitude of clients, examples of which are illustrated as clients 104, 106.

The network operator 102 is also illustrated as including an access network 124 having a network authority module 126 and a backend 128 having an API 130. The access network 124 and the network authority module 126 are representative of functionality of the network operator 102 to communicate content over the network 110 to the clients 104, 106. For example, the access network 124 may be representative of one or more devices of the network operator 102 that may be used to multiplex the television content 114 for communication over a packetized network connection to the clients 104, 106, e.g., a digital subscriber line (DSL).

The backend 128 is also illustrated as including a client permissions module 132, which is representative of functionality of the network operator 102 that is accessible via the API 130 to determine conditional access rights of the clients 104, 106 to access the television content 114. For example, the network authority module 126 may check with the client permissions module 132 via the API 130 to determine whether the clients 104, 106 are permitted to access requested television content 114. The network authority module 126 may then block or permit the television content 114 to be streamed via the access network 124 and the network 110 as a result of this determination.

In this way, the network authority module 126 and the client permissions module 132 may prevent the television content 114 from being streamed to clients that are not permitted to access the television content 114. Thus, regardless of whether the private keys stored by the respective clients 104, 106 become exposed, content consumption of the clients 104, 106 may still be managed by the network authority module 126 and the client permissions module 132 of the network operator 102 by controlling which streams of the television content 114 are made accessible to which clients. A variety of other techniques may also be used to determine whether television content consumption by the clients 104, 106 is permitted, which may then be used to manage whether to stream or block access to the television content 114.

For example, the clients 104, 106 are each illustrated as including a log 134, 136 respectively. Each of the logs 134, 136 in this example are formed by the respective client communication modules 118, 120 to describe interaction of the respective clients 104, 106 with television content 114. The logs 134, 136 may be collected by the network authority module 126 of the network operator 102 which may then be used to determine whether the television content 114 accessed by the respective clients 104, 106 is permitted.

For instance, the network authority module 126 may query the client permissions module 132 via the API 130 to determine whether network addresses described in the respective blocks 134, 136 correspond to permitted television content 114. A result of this determination may then be used to manage provision of subsequent television programming, such as to block or stream particular television content 114 to the respective clients 104, 106. Further discussion of the use of logs 134, 136 to manage television content for the clients 104, 106 may be found in relation to FIG. 5.

FIG. 2 depicts a system 200 in an example implementation in which the network authority module 126 of FIG. 1 is illustrated as being implemented by a digital subscriber line access multiplexer (DSLAM) 202. The DSLAM 202 is illustrated as part of the access network 124 that is utilized to communicate television content 114 to client 104. The DSLAM 202 is a network device that is operable to connect a plurality of digital subscriber lines to an Internet backbone using one or more multiplexing techniques. Each of the plurality of digital subscriber lines is connectable the respective one or more of plurality of clients, an example which is shown by client 104 in FIG. 2.

DSLAMs are generally implemented as network devices located near the clients location to connect multiple client digital subscriber lines to a high-speed Internet backbone. Although a traditional DLAM was utilized to provide a network connection to clients through the Internet backbone, the DSLAM do not know what data was being provided via the network connection. Consequently, the traditional DSLAM was incapable of knowing which data was being delivered to which clients, and therefore digital rights management regarding the data could not be performed using a traditional DSLAM.

In the illustrated implementation, however, the DSLAM 202 is illustrated as including the functionality of the network authority module 126 of FIG. 1, which may be used in conjunction with the backend 128 to manage provision of the television content 114 to the client 104. For example, the client 104 may receive a request for television content 114 via the client communication module 118. The client 104 may then translate an identifier of the television content (e.g., a name of a television program) to a network address using a content/network address translation module 204. The client 104 may then form a request 206 that includes a client identifier 208 that uniquely identifies the client 104 (e.g., a MAC address) from other clients (e.g., client 106) and the network address 208. The request 206 is illustrated in the system 200 of FIG. 2 is being communicated to the DSLAM 202 of the access network 124.

The DSLAM 202 may then receive the request 206 and determine, using data contained within the request 206, whether the client 104 is permitted to receive the television content identified in a request before streaming the identified content to the client 104. This determination may be made in a variety of ways.

For example, the network authority module 126 of the DSLAM 202 may form an API call 210 that includes a client identifier 214 and a network address 216 that match the client identifier 208 and the network address 210 included in the request 206. The API call 212 is communicated to the API 130 of the backend 128.

The backend 128 is illustrated as including a client permissions module 218 and a network address/content translation module 220. The client permissions module 218 is representative of functionality of the backend 128 to determine whether the client 104 is permitted to access the requested television content. For example, the client permissions module 218 may utilize the network address/content translation module 220 to translate the network address 216 into a content identifier. This content identifier, which may or may not match the television content identifier originally received at the client communication module 118, may then be used to check whether the client 104 is permitted to access the television content. For instance, the client permissions module 218 may use the translated content identifier in conjunction with the client identifier 214 to verify whether the client 104 is permitted to access the television content using a listing of client conditional access rights 222. The client conditional access rights 222, for instance, may use the client identifier 214 as an index to locate which of the television content 114 the client 104 is permitted and/or not permitted to access. Although the client conditional access rights 222 are illustrated as stored in storage at the backend 128, the client conditional access rights 222 may be stored and maintained in a variety of other locations.

The client permissions module 218 may then form an answer 224 that includes the client identifier 226 and a result 228 of the determination, e.g., whether client 104 is permitted to access the requested television content 114. The DSLAM 202 may then use this information to manage provision of the television content 104 to the client 104. For example, the DSLAM 202 may enable or disable ports used to stream television content 114 to the client 104. Thus, the DSLAM 202 may stream or block the television content 114 based on the determination of whether the client 104 is permitted to receive the television content 114. In this way, exposure of a private key of another client (e.g., client 106) does not provide client 104 with the ability to output the television content 114 since the client 104 does not receive the television content 114. A variety of other examples are also contemplated, such as the use of logs to manage provision of television content to the clients 104, 106, further discussion of which may be found in relation to the following procedures.

Generally, any of the functions described herein can be implemented using software, firmware, hardware (e.g., fixed-logic circuitry), manual processing, or a combination of these implementations. The terms “module”, “functionality” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer-readable memory devices. The features of the techniques to manage television content are platform-independent, meaning that the techniques may be implemented on a variety of commercial computing platforms having a variety of processors.

Example Procedures

The following discussion describes management techniques that may be implemented utilizing the previously described environment, systems, user interfaces and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and system 200 of FIG. 2, respectively.

FIG. 3 depicts a procedure 300 in an example implementation in which client consumption of content is managed using an API call to a backend. A request is received at a client to output television content (block 302). For example, a user may select television content using a channel up or channel down button on a remote control, via an electronic program guide, and so on. As previously described, the client may be configured in a variety of ways, such as a television, a set-top box, a television enabled personal computer, a mobile phone that receives streams of the television content via a wireless network, and so on.

The requested television content is then translated to a network address (block 304) by the client. For example, the client communication module 118 may employ the content/network address translation module 204 to translate a content identifier (e.g. a name of a television program) to a network address e.g., a multicast address.

A request is formed that includes a network address and a client identifier (block 306). For example, the request may be formed to include a header for communication over a packetized network of an access network 124, e.g., a DSLAM 202. Thus, the request may be received at the access network (block 308) of the network operator 102, such as at the DSLAM 202 as previously described.

A call is formed to an application programming interface (API) that includes the client identifier and the network address to determine whether the client is permitted to receive the television content from the network address (block 310). For example, the DSLAM 202 may form the call to be received at the backend (block 312) of the network operator 102.

The network address in the call is translated to identify the television content (block 314). For example, a client permissions module 218 may be employed at the backend 128 and use a network address/content translation module 220 to determine an identity of content that is available at the network address 216 (e.g., a multicast address) included in the API call 212.

A determination is then made as to whether the client corresponding to the client identifier is permitted to consume the identified television content (block 316). Continuing with the previous example, the client permissions module 218 may access client conditional access rights 222 using the client identifier 214 to determine an identity of the client 104 and the network address to determine which content is being requested by the client 104. For instance, the network operator 102 may provide different subscription options for accessing the television content 114, provide pay-per-view television content and/or video-on-demand television content for a fee, and so on. Accordingly, the client conditional access rights 222 may reflect which conditional access rights have been granted by the network operator 102 to the client 104.

An answer may then be formed to be communicated from the backend to the access network via the API that includes a result of the determination (block 318). Communication of the television content to the client may then be managed by the access network based on answer (block 320). For example, the DSLAM 202 may open or close respective ports based on whether the client 104 is permitted to access content via multicast addresses that are made available via those ports. In another example, the network operator (and more particularly the network authority module 126) may choose whether to stream or not stream the television content to the client 104. For instance, the network operator 102 may prevent streaming of specific television content that is not permitted to be consumed by the client 104 yet permit other content to be streamed to the client 104 that is permitted to be consumed by the client 104. In another instance, the network operator 102 may block each stream of the television content 114 that would otherwise be available from the network operator 102 from being streamed to the client 104. A variety of other management techniques may also be utilized by the network operator 102 to manage content consumption by a client, an example of which may be found in relation to the following figure.

FIG. 4 depicts a procedure 400 in an example implementation in which communication of television content to a client is managed based on a log collected from the client that describes interaction of the client with television content. Interaction of a client with television content is monitored (block 402). A log is then form that describes the monitored interaction (block 404). The client 104, for instance, may execute the client communication module 118 to log each item of television content 114 consumed at the client 104. In another example, the log may be created by the access network 124, e.g., the DSLAM 202. In a further example, the log may be a digital subscriber line access multiplexer (DSLAM) event log. A variety of others examples are also contemplated.

The log is collected by a network operator (block 406). The client 104 may upload the log 116 to the network operator 102 at regular intervals, at predetermined times, in response to a request by the network operator 102, may be “pulled” from the client 104 by the network operator 102, and so on.

A determination is then made as to whether the client was permitted to access the television content described in the log (block 408). For example, the network operator 102 may incorporate functionality represented by the backend 128 (as previously described in greater detail in relation to FIG. 3) to determine whether the client 104 was permitted to access each item of the television content 114 referenced in the log 116. Communication of the television content to the client may then be managed based on the determination (block 410), which again may be used by one or more of the management techniques that were previously described in relation to FIGS. 1-3. Thus, like the API techniques previously described, the network operator may employ a DSLAM 202 or other access network device to block or permit streaming of television content 114 to the client 104. A variety of other techniques may also be utilized without departing from the spirit and scope thereof.

Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
forming a call to an application programming interface (API) to include an identifier of a client that requested television content and a network address via which the television content is accessible; and
managing whether the television content is to be streamed to the client based on an answer that:
is received responsive to the call; and
includes a result of a determination of whether the client is permitted to consume the television content from the network address.

2. A method as described in claim 1, wherein:
the forming and the managing are performed by one or more modules of an access network of a network operator; and
the API is provided by a backend of the network operator.

3. A method as described in claim 1, wherein the forming and the managing are performed by a digital subscriber line access multiplexer (DSLAM).

4. A method as described in claim 1, wherein the network address is a multicast address received from the client.

5. A method as described in claim 1, wherein the managing is performed such that the client does not receive a stream of the requested television content when the client is not permitted to consume the television content from the network address.

6. A method as described in claim 5, the managing is performed such that the client is permitted to receive a stream of other television content from another network address by a network operator that performs the forming and the managing when the client is not permitted to consume the requested television content from the network address.

7. A method as described in claim 1, further comprising:
collecting a log that describes interaction of the client with television content;
determining whether the client is permitted to access the television content described in the log; and
managing communication of subsequent television content based on the determining.

8. A method as described in claim 7, wherein the managing includes blocking specific streams of the television content to the client that the client is not permitted to access.

9. A method as described in claim 1, wherein the television content is to be streamed to the client over an Internet Protocol (IP) network.

10. A method comprising:
collecting a log by a network operator that describes interaction of a client with television content;
determining whether the client is permitted to access the television content described in the log; and
managing communication of subsequent television content based on the determining.

11. A method as described in claim 10, wherein:
the log is collected from the client; and
the client monitors the interaction with the television content.

12. A method as described in claim 10, wherein the log describes interaction by the client with multicast addresses that are used to stream the television content to the client.

13. A method as described in claim 10, wherein the log is a digital subscriber line access multiplexer (DSLAM) event log.

14. A method as described in claim 10, wherein the managing includes blocking specific streams of the television content to the client that the client is not permitted to access.

15. A method as described in claim 10, wherein the communication of the subsequent television content is to be performed using an Internet Protocol (IP) network.

16. An apparatus comprising one or more modules to:
connect a plurality of digital subscriber lines to an Internet backbone using one or more multiplexing techniques, in which each of the plurality of digital subscriber lines is connectable to a respective one or more of a plurality of clients; and
managing whether requested television content is to be streamed to one or more said clients by forming a call to an application programming interface (API) to determine whether the one or more said client are permitted to receive the requested television content.

17. An apparatus as described in claim 16, wherein the call to the application programming interface is to be communicated over the Internet backbone.

18. An apparatus as described in claim 16, wherein the managing includes blocking specific streams of the television content to the one or more said clients that the one or more said clients are not permitted to access

19. An apparatus as described in claim 16, wherein the managing includes blocking each stream of television content from the one or more modules to the one or more said clients when the one or more said clients are not permitted to access the requested television content.

20. A digital subscriber line access multiplexer (DSLAM) that includes the apparatus as described in claim 16.
